(19) United States
(12) Patent Application Publication
(10) Pub. No.: US 2023/0106335 A1
(43) Pub. Date: Apr. 6, 2023

(54) SYSTEMS AND METHODS TO PROACTIVELY ALERT ADMINS FOR UPCOMING OR POSSIBLE NETWORK OUTAGES IN A SPECIFIC LOCATION

(71) Applicant: Citrix Systems, Inc., Fort Lauderdale, FL (US)

(72) Inventors: Prabhjeet Singh Chawla, Kanpur (IN); Reetika Agarwal, Bangalore (IN); Vikramjeet Singh Sandhu, Punjab (IN)

(73) Assignee: Citrix Systems, Inc., Fort Lauderdale, FL (US)

(21) Appl. No.: 17/490,796

(22) Filed: Sep. 30, 2021

(51) Int. Cl. H04L 12/26

(52) U.S. Cl. CPC H04L 43/0811; H04L 43/0817; H04L 43/0876

(57) ABSTRACT

Systems and methods for proactively alerting administrators of upcoming or possible network outages include a server which receives metrics for usage of one or more networks for each workspace application of plurality of workspace applications of a plurality of endpoints across a plurality of different locations of an enterprise. The server may determine a network download speed for each location of the plurality of different locations according to the metrics for each workspace application. The server may generate an alert to be provided to a device of a user associated with a first location of the plurality of different locations responsive to the network download speed for a network of the one or more networks falling below a threshold.

### FIELD OF THE DISCLOSURE

The present application generally relates to network diagnostics. In particular, the present application relates to systems and methods for alerting administrators of upcoming or possible network outages in a specific location.

### BACKGROUND

In various computing environments, network connectivity may be necessary to provide basic functionalities. At times, networks may experience issues which may lead to network outages or degraded user experiences.

### BRIEF SUMMARY

In various computing environment deployments, an enterprise may include various data centers and branch offices. Each branch office may include one or more networks in which endpoints connect. At times, issues may arise related to the network(s) in the branch offices that may lead to outages or degraded user experiences. According to the systems and methods described herein, a server may collect, ingest, or otherwise receive metrics from endpoints associated with the enterprise, and proactively warn administrator devices regarding degradation of networks in any branch offices, to eliminate or avoid potential network outages. The server may receive metrics from a workspace application executing on the endpoints. The workspace application may facilitate connection with various resources at the endpoints. For example, the workspace application may provide a user with access to remotely-hosted resources (such as applications, programs, data, etc.), local resources, and the like. As such, the workspace application may be uniquely suitable for providing metrics relating to network performance at the endpoint upon with the workspace application is executing. The metrics may include, for instance, network speed (i.e., download speed), bandwidth information, and internet service provider (ISP) information, among other metrics. The systems and methods described herein may correlate the metrics with potential outages and/or degradations in network performance to generate alerts before such issues occur.

According to the systems and methods described herein, the server may compute a network performance score, measure, or other value based on the metrics received from the endpoints. The network performance value may be or include a daily or weekly average of the metrics (or a value computed based on the metrics). The server may compare the network performance value to a threshold. The threshold may be, for example, a threshold percentage drop in performance from a historical or past average. The systems and methods described herein may automatically generate an alert or notification for a computing device associated with administrator, indicating a potential network outage or degradation in performance.

According to the systems and methods described herein, the server may leverage workspace applications, which may be ubiquitous in various enterprises and at branch locations, for providing metrics relating to network performance of network(s) at the branch locations. The metrics may be received at various intervals throughout the day, which may provide granularity in the metrics. By providing more granularity in the metrics, the systems and methods described herein may detect degradation in network performance in near real-time and correspondingly generating alerts relating to the network performance. Various other advantages of the present solution are described in greater detail below.

In one aspect, this disclosure is directed to a method. The method includes receiving, by one or more servers from a plurality of workspace applications of a plurality of endpoints across a plurality of different locations of an enterprise, metrics for usage of one or more networks for each workspace application. The method includes determining, by the one or more servers according to the metrics for each workspace application, a network download speed for each location of the plurality of different locations. The method includes generating, by the one or more servers, an alert to be provided to a device of a user associated with a first location of the plurality of different locations responsive to the network download speed for a network of the one or more networks falling below a threshold.

In some embodiments, the workspace applications execute on endpoints to provide a user of the endpoint access to a plurality of local or remote resources. In some embodiments, the metrics include an average network download speed for a current time interval, and the threshold includes a percentage drop of the average network download speed for the current time interval from an average network download speed for a previous time interval. In some embodiments, the metrics include network download speed and at least one of a network name, an address, a network interface type, or an internet service provider for the respective networks. In some embodiments, the method further includes computing, by the one or more servers, a performance score based on the metrics including the network download speed, wherein the alert is generated responsive to the performance score falling below the threshold. In some embodiments, the network interface type includes at least one of an Ethernet network interface, a Wi-Fi network interface, a token-ring network interface, a fiber distributed data interface (FDDI) network interface, a point-to-point (PPP) network interface, a loopback network interface, or a serial line internet protocol (SLIP) network interface.

In some embodiments, the alert indicates at least one of an existing network interruption or a potential network interruption. In some embodiments, at least some of the metrics are received from a plurality of probe services executing at the respective network locations. In some embodiments, at least some of the plurality of networks including the network are located at a common geographic location, and the alert indicates that the first network located at the common geographic location is experiencing an degradation in network connectivity. In some embodiments, the method further includes causing, by the one or more servers, an endpoint connected to the network to render a notification indicating a degradation in network connectivity.

In another aspect, this disclosure is directed to a system. The system includes one or more processors configured to receive, from a plurality of workspace applications of a plurality of endpoints across a plurality of different locations of an enterprise, metrics for usage of one or more networks for each workspace application. The one or more processors are further configured to determine, according to the metrics for each workspace application, a network download speed for each location of the plurality of different locations. The one or more processors are further configured to generate an alert to be provided to a device of a user associated with a first location of the plurality of different locations responsive to the network download speed for a network of the one or more networks falling below a threshold.

In some embodiments, the workspace applications execute on endpoints to provide a user of the endpoint access to a plurality of local or remote resources. In some embodiments, the metrics include an average network download speed for a current time interval, and the threshold includes a percentage drop of the average network download speed for the current time interval from an average network download speed for a previous time interval. In some embodiments, the metrics include network download speed and at least one of a network name, an address, a network interface type, or an internet service provider for the respective networks. In some embodiments, the one or more processors are further configured to compute a performance score based on the metrics including the network download speed, wherein the alert is generated responsive to the performance score falling below the threshold.

In some embodiments, the network interface type includes at least one of an Ethernet network interface, a Wi-Fi network interface, a token-ring network interface, a fiber distributed data interface (FDDI) network interface, a point-to-point (PPP) network interface, a loopback network interface, or a serial line internet protocol (SLIP) network interface. In some embodiments, the alert indicates at least one of an existing network interruption or a potential network interruption. In some embodiments, at least some of the metrics are received from a plurality of probe services executing at the respective network locations. In some embodiments, at least some of the plurality of networks including the network are located at a common geographic location, and the alert indicates that the first network located at the common geographic location is experiencing an degradation in network connectivity.

In yet another aspect, this disclosure is directed to a non-transitory computer readable medium which stores instructions. The instructions, when executed by one or more processors, cause the one or more processors to receive, from a plurality of workspace applications of a plurality of endpoints across a plurality of different locations of an enterprise, metrics for usage of one or more networks for each workspace application. The instructions further cause the one or more processors to determine, according to the metrics for each workspace application, a network download speed for each location of the plurality of different locations. The instructions further cause the one or more processors to generate an alert to be provided to a device of a user associated with a first location of the plurality of different locations responsive to the network download speed for a network of the one or more networks falling below a threshold.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device;

FIG. 1B is a block diagram depicting a computing environment comprising client device in communication with cloud service providers;

FIG. 2A is a block diagram of an example system in which resource management services may manage and streamline access by clients to resource feeds (via one or more gateway services) and/or software-as-a-service (SaaS) applications;

FIG. 2B is a block diagram showing an example implementation of the system shown in FIG. 2A in which various resource management services as well as a gateway service are located within a cloud computing environment;

FIG. 2C is a block diagram similar to that shown in FIG. 2B but in which the available resources are represented by a single box labeled “systems of record,” and further in which several different services are included among the resource management services;

FIG. 3 is a block diagram of an embodiment of a system for proactively alerting administrators of upcoming or possible network outages in a specific location in accordance with an illustrative embodiment;

FIG. 4 is a series of charts showing network performance of one or more networks over time in accordance with an illustrative embodiment;

FIG. 5 is a flow diagram of an embodiment of a method for proactively alerting administrators of upcoming or possible network outages in a specific location in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In various computing environment deployments, an enterprise may include various data centers and branch offices. Each branch office may include one or more networks in which endpoints connect. At times, issues may arise related to the network(s) in the branch offices that may lead to outages or degraded user experiences. According to the systems and methods described herein, a server may collect, ingest, or otherwise receive metrics from endpoints associated with the enterprise, and proactively warn administrator devices regarding degradation of networks in any branch offices, to eliminate or avoid potential network outages. The server may receive metrics from a workspace application executing on the endpoints. The workspace application may facilitate connection with various resources at the endpoints. For example, the workspace application may provide a user with access to remotely-hosted resources (such as applications, programs, data, etc.), local resources, and the like. As such, the workspace application may be uniquely suitable for providing metrics relating to network performance at the endpoint upon with the workspace application is executing. The metrics may include, for instance, network speed (i.e., download speed), bandwidth information, and internet service provider (ISP) information, among other metrics. The systems and methods described herein may correlate the metrics with potential outages and/or degradations in network performance to generate alerts before such issues occur.

According to the systems and methods described herein, the server may compute a network performance score, measure, or other value based on the metrics received from the endpoints. The network performance value may be or include a daily or weekly average of the metrics (or a value computed based on the metrics). The server may compare the network performance value to a threshold. The threshold may be, for example, a threshold percentage drop in performance from a historical or past average. The systems and methods described herein may automatically generate an alert or notification for a computing device associated with administrator, indicating a potential network outage or degradation in performance.

According to the systems and methods described herein, the server may leverage workspace applications, which may be ubiquitous in various enterprises and at branch locations, for providing metrics relating to network performance of network(s) at the branch locations. The metrics may be received at various intervals throughout the day, which may provide granularity in the metrics. By providing more granularity in the metrics, the systems and methods described herein may detect degradation in network performance in near real-time and correspondingly generating alerts relating to the network performance. Various other advantages of the present solution are described in greater detail below.

For purposes of reading the description of the various embodiments below, the following descriptions of the sections of the specification and their respective contents may be helpful:

Section A describes a computing environment which may be useful for practicing embodiments described herein;

Section B describes resource management services for managing and streamlining access by clients to resource feeds; and

Section C describes systems and methods for proactively alerting admins of upcoming or possible network outages in a specific location.

### A. Computing Environment

Prior to discussing the specifics of embodiments of the systems and methods of an appliance and/or client, it may be helpful to discuss the computing environments in which such embodiments may be deployed.

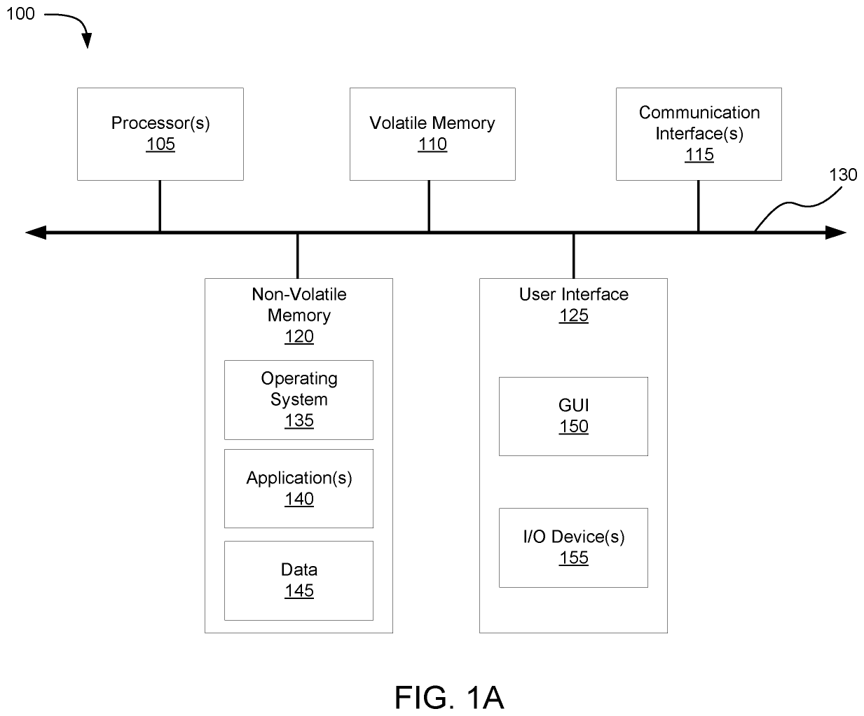

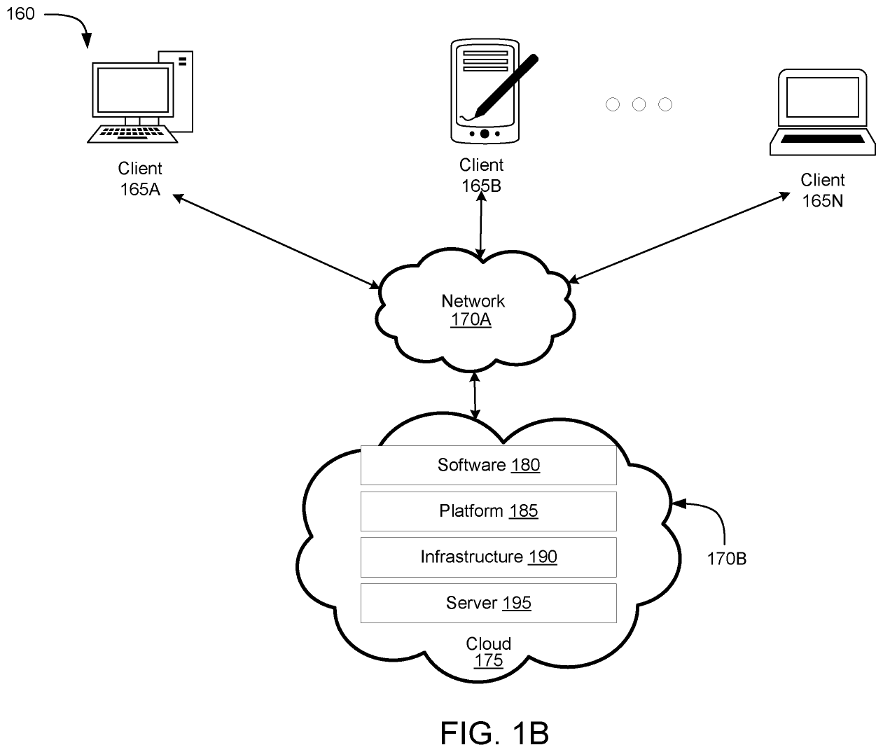

As shown in FIG. 1A, computer 100 may include one or more processors 105, volatile memory 110 (e.g., random access memory (RAM)), non-volatile memory 130 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 135, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 130 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 135 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170. Clients 165 may include, e.g., thick clients, thin clients, and zero clients. The cloud 108 may include back end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Resource Management Services for Managing and Streamlining Access by Clients to Resource Feeds

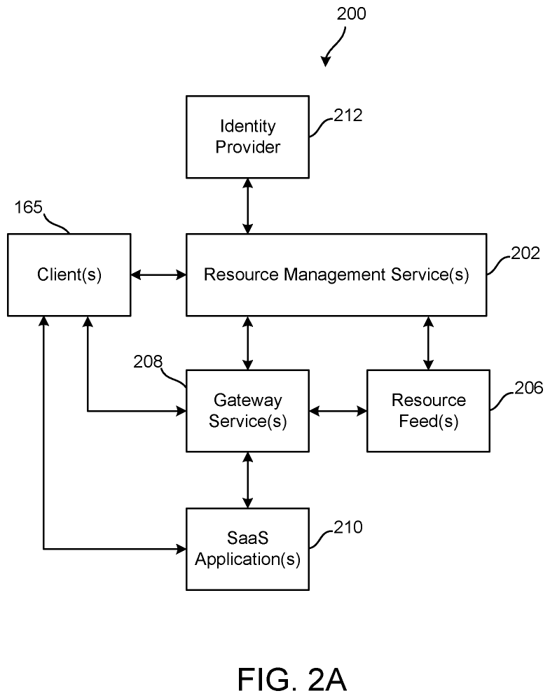

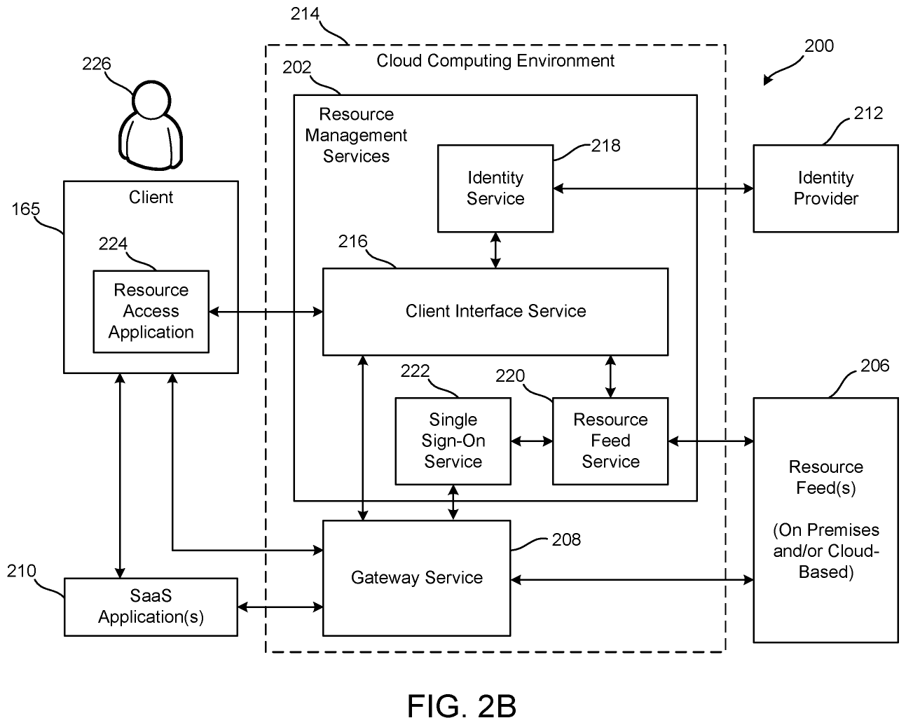

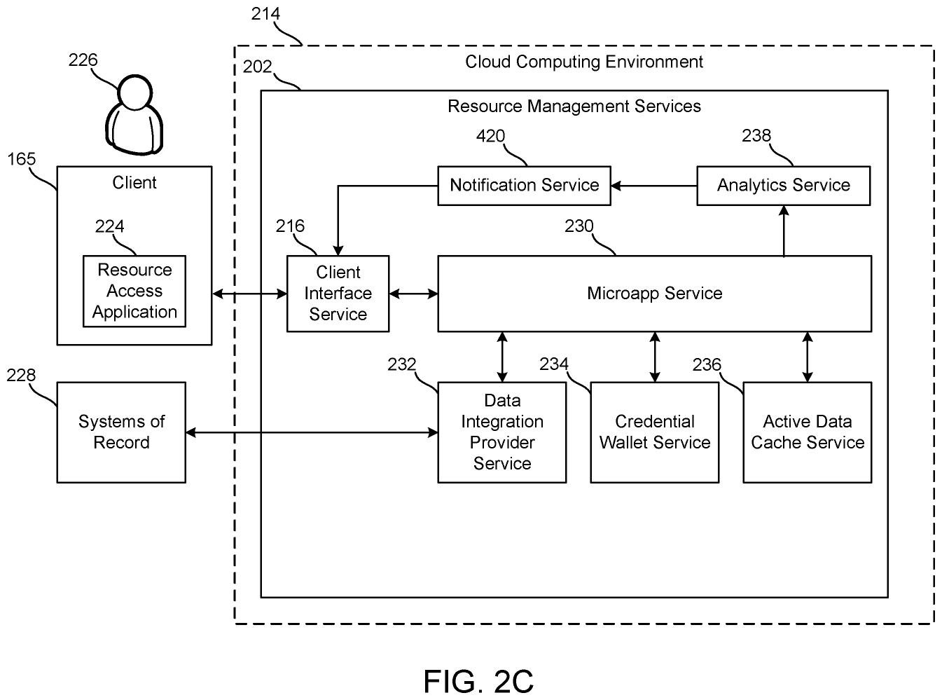

FIG. 2A is a block diagram of an example system 200 in which one or more resource management services 202 may manage and streamline access by one or more clients 202 to one or more resource feeds 206 (via one or more gateway services 208) and/or one or more software-as-a-service (SaaS) applications 210. In particular, the resource management service(s) 202 may employ an identity provider 212 to authenticate the identity of a user of a client 165 and, following authentication, identify one of more resources the user is authorized to access. In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 202 may be any type of computing devices capable of accessing the resource feed(s) 206 and/or the SaaS application(s) 210, and may, for example, include a variety of desktop or laptop computers, smartphones, tablets, etc. The resource feed(s) 206 may include any of numerous resource types and may be provided from any of numerous locations. In some embodiments, for example, the resource feed(s) 206 may include one or more systems or services for providing virtual applications and/or desktops to the client(s) 202, one or more file repositories and/or file sharing systems, one or more secure browser services, one or more access control services for the SaaS applications 210, one or more management services for local applications on the client(s) 202, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud computing environment may, for example, include Microsoft Azure Cloud, Amazon Web Services, Google Cloud, or IBM Cloud.

For any of illustrated components (other than the client 165) that are not based within the cloud computing environment 214, cloud connectors (not shown in FIG. 2B) may be used to interface those components with the cloud computing environment 214. Such cloud connectors may, for example, run on Windows Server instances hosted in resource locations and may create a reverse proxy to route traffic between the site(s) and the cloud computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 224 is launched or otherwise accessed by the user 226, the client interface service 216 may send a sign-on request to the identity service 218. In some embodiments, the identity provider 212 may be located on the premises of the organization for which the system 200 is deployed. The identity provider 212 may, for example, correspond to an on-premises Windows Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user's authentication credentials (e.g., user-name and password). Upon receiving the user's authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user's identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a Microsoft Azure Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user's authentication credentials. Upon determining the user's identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user's identity has been properly authenticated, the client interface service 216 may send a request to the resource feed service 220 for a list of subscribed resources for the user 226.

For each configured resource feed, the resource feed service 220 may request an identity token from the single sign-on service 222. The resource feed service 220 may then pass the feed-specific identity tokens it receives to the points of authentication for the respective resource feeds 206. Each resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource application 224 is located remotely), e.g., via a secure browser service. In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 165 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 226 of something that requires the user's attention (e.g., approval of an expense report, new course available for registration, etc.).

FIG. 2C is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 2C may enable the provision of a streamlined resource activity feed and/or notification process for a client 165. In the example shown, in addition to the client interface service 216 discussed above, the illustrated services include a microapp service 230, a data integration provider service 232, a credential wallet service 234, an active data cache service 236, an analytics service 238, and a notification service 240. In various embodiments, the services shown in FIG. 2C may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 2C may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 2C, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the credential wallet service 234 may store encrypted service credentials for the systems of record 228 and user OAuth2 tokens.

In some embodiments, the data integration provider service 232 may interact with the systems of record 228 to decrypt end-user credentials and write back actions to the systems of record 228 under the identity of the end-user. The write-back actions may, for example, utilize a user's actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

Finally, in some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the credential wallet service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the credential wallet service 234 an encrypted Oauth2 token for the system of record for which the action is to be invoked, and may send the action to the data integration provider service 232 together with the encrypted Oath2 token. The data integration provider service 232 may then decrypt the Oath2 token and write the action to the appropriate system of record under the identity of the user 226. The data integration provider service 232 may then read back changed data from the written-to system of record and send that changed data to the microapp service 230. The microapp service 232 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 202 may, for example, parse these requests and respond because they are integrated with multiple systems on the back-end. In some embodiments, users may be able to interact with the virtual assistance through either the resource access application 224 or directly from another resource, such as Microsoft Teams. This feature may allow employees to work efficiently, stay organized, and deliver only the specific information they are looking for.

### C. Systems and Methods for Proactively Alerting Admins of Upcoming or Possible Network Outages in a Specific Location

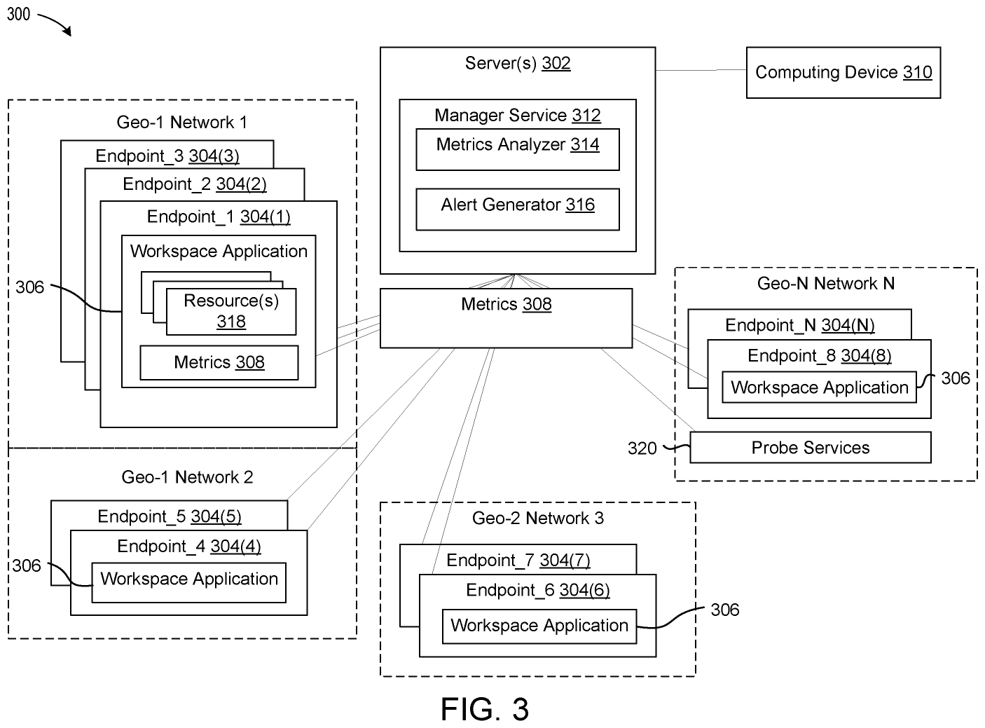

Referring now to FIG. 3, depicted is a block diagram of a system 300 for proactively alerting administrators of upcoming or possible network outages in a specific location. The system 300 is shown to include one or more servers 302 communicably coupled to various endpoints 304. The endpoints 304 may be located at various geographic locations and communicably coupled to various network(s) at the geographic locations. The endpoints 304 may be configured to execute a workspace application 306. The workspace application 306 may be configured to gather, acquire, collect, or otherwise identify metrics 308 for usage of the network(s) in which the endpoint is communicably coupled. The workspace application 306 may be configured to transmit the metrics to the server(s) 302. The server(s) 302 may be configured to receive the metrics 308. The server(s) 302 may be configured to determine a network download speed for each location. The server(s) 302 may be configured to generate an alert to be provided to a device 310 (i.e., a computing device 310) of a user associated with a respective location responsive to the network download speed falling below a threshold.

Each of the above-mentioned elements or entities is implemented in hardware, or a combination of hardware and software, in one or more embodiments. Each component of the system 300 may be implemented using hardware or a combination of hardware or software detailed above in connection with Sections A and B. For instance, each of these elements or entities can include any application, program, library, script, task, service, process or any type and form of executable instructions executing on hardware of the system 300. For example, the server(s) 302 may include a manager service 312 including a metrics analyzer 314 and an alert generator 316. The manager service 312, metrics analyzer 314, and/or alert generator 316 may be or include any application, program, library, script, task, service, process or any type and form of executable instructions executing on hardware of the server(s) 302. The hardware may include circuitry, such as one or more processors in one or more embodiments.

As shown in FIG. 3, the system 300 may include endpoints 304 located at various geographic locations and communicably coupled to various networks. The geographic locations may include various buildings, office spaces, or other locations associated with an enterprise. In some instances, some geographic locations may include multiple networks. For example, the first geographic location Geo-1 includes two networks (i.e., Network 1 and Network 2). Additionally, other geographic locations may include any number of networks. The networks may be or include an ethernet network, WiFi network, a token-ring network, an fiber distributed data interface (FDDI) network, a point-to-point (PPP) network, a loopback network, or a serial line internet protocol (SLIP) network, and so forth. The endpoints 304 may include various interfaces for establishing a connection with the networks at each geographic location. The interfaces may be or include any device, component, or other circuitry configured to establish a connection with a network. In some embodiments, the interfaces may include a combination of hardware (such as antennas, circuitry, connectors, etc.) which facilitate establishing a connection with a network. For example, the endpoints 304 may include an Ethernet network interface, WiFi network interface, token-ring network interface, FDDI network interface, PPP network interface, loopback network interface, SLIP network interface, and so forth.

The system 300 is shown to include a computing device 310. The computing device 310 may be similar to one of the clients 165 described above with reference to FIG. 1A-FIG. 1C. The computing device 310 may be a device which is used by an administrator (such as a network administrator, information technology (IT) administrator, etc.) for the enterprise. In some embodiments, the computing device 310 may be located at one of the respective geographic locations. For instance, each geographic location may include a respective computing device 310 which is used by an administrator for that respective geographic location. In another example, the computing device 310 may be located at any of the respective geographic locations. For example, the computing device 310 may be a mobile computing device 310 for an administrator which services multiple networks for several (including but not limited to each) of the geographic locations.

The system 300 is shown to include a plurality of endpoints 304. In some embodiments, the endpoints 304 may be clients 165 (similar to the clients 165 described above with reference to FIG. 1A-FIG. 1C). The endpoints 304 may be communicably coupled to networks located at a respective geographic location. As shown in FIG. 3, a first set of endpoints 304(1)-304(3) may be communicably coupled to a first network (Network 1) at a first geographic location, a second set of endpoints 304(4)-304(5) may be communicably coupled to a second network (Network 2) at the first geographic location, a third set of endpoints 304(6)-304(7) may be communicably coupled to a third network (Network 3) at a second geographic location, and an N-th set of endpoints 304(8)-304(N) may be communicably coupled to an N-th network (Network N) at an N-th geographic location. It is noted that various combinations of geographic locations, networks, and any number of endpoints may be provided or incorporated in the system 300. Each of the endpoints 304 may include a network interface for establishing a communications link with a respective network at the geographic location.

The endpoints 304 are shown to execute a workspace application 306. The workspace application 306 may be or include a program, application, script, software, or other executable code configured to execute on the endpoints 304 to provide a user of the endpoint 304 access to various local or remote resources 318. The workspace application 306 may be the same as or similar to the resource access application 224 described above with reference to FIG. 2A-FIG. 2C. As such, the workspace application 306 may be configured to provide a user of the endpoint 304 with access to various resources of the enterprise. For example, the workspace application 306 may be configured to provide a user of the endpoint 304 access to various SaaS applications 210, on-premise or cloud-based resources, web applications, Windows applications, Linux applications, desktops, file repositories and/or file sharing systems, and other data. The resources 310 may be listed or otherwise provided to the user of the endpoint 304 in the systems of record 228 as described above. Since the workspace application 306 executes locally and is configured to provide a user with access to various resources, which may be hosted locally or remotely, the workspace application 306 may use the network connection of the endpoint to provide such access. As such, the workspace application 306 may be communicably coupled to a network at the respective geographic location of the endpoint 304 to provide a user of the endpoint 304 access to the resources of the enterprise.

The workspace applications 306 of the endpoints 304 may be configured to receive, collect, determine, or otherwise identify various metrics of the network to which the endpoint 304 is connected at the geographic location. In some embodiments, the workspace application 306 may include a script (i.e., a background script) executing on the endpoints 304 to identify metrics of the network. As such, the workspace applications 306 may be configured to identify metrics of the network without any interruption of services and/or resources provided via the workspace application 306 to the user. The workspace applications 306 may be configured to identify metrics of the network, endpoint, geographic location, etc. The metrics may include, for example, an average download speed, an average upload speed, a maximum download speed, a maximum upload speed, a network interface type, a network name, a session identifier, a speed unit, a device identifier, a launch source, an operating system, a timestamp, a timezone, and so forth. The workspace applications 306 may be configured to identify the metrics of the network, endpoint, geographic location, etc. at various intervals. For example, the workspace applications 306 may be configured to identify the metrics every minute, every five minutes, every ten minutes, every 15 minutes, every 30 minutes, every hour, every two hours, every four hours, every six hours, every 12 hours, daily, etc.

In some embodiments, the workspace applications 306 may be configured to generate a string, report, or other data packet including the metrics 308 for sending to the server 302. The workspace applications 306 may be configured to generate the data packet using the metrics identified by the workspace application 306. In some embodiments, the workspace applications 306 may generate the data packet to include the metrics 308 as a payload and a header which identifies the metrics included in the data packet. One example data packet is provided below:

```
  {
    “EventHubDetails”:{
      “EHName”:“citrixanalyticseh.servicebus.windows.net.”,
      “PartitionID”:18,
      “messageAnnotation”:{
        “x-opt-enqueued-time”:1620135080101,
        “x-opt-offset”:“754935004395048”,
        “x-opt-partition-key”:“dtyz08c8bmj5.ath.sub.896eef47-9cf5-49ec-
      9d1e-cf7cc830273f”,
        “x-opt-publisher”:“dtyz08c8bmj5.ath.sub.896eef47-9cf5-49ec-
      9d1e-cf7cc830273f”,
        “x-opt-sequence-number”:2463176293
      }
  },
    “computerManufacturer”:“LENOVO”,
    “computerName”:“20FMA0BWIG”,
    “dvc”:“BANLVEDA”,
    “hardwareID”:“fd80c75a-00b4-5eb5-b3d2-7e04042c70c8”,
  “header-
keys”:“computerManufacturer,computerName,dvc,hardwareID,id,ip,payload,prod,prodVer,publi
cIPv4,publicIPv6,st,tenant,type,user,ver”,
  “id”:“6DDC23F3-5DB3-4028-B5CD-B687CB06E5C1”,
  “ip”:“169.254.151.124”,
  “payload”:{
    “AvgDownloadSpeed”:“0”,
    “AvgUploadSpeed”:“0”,
    “MaxDownloadSpeed”:“0”,
    “MaxUploadSpeed”:“0”,
    “NetworkInterfaceType”:“Wifi”,
    “NetworkName”:“Vihaan Homestead 7”,
    “SessionId”:“{656828C4-D52F-4689-A2A2-9B4354BC6546},{513DEE37-1849-
4959-964E-496765ACCE0A}”,
    “SpeedUnit”:“Bps”,
    “deviceId”:“BANLVEDA”,
    “launchSource”:“InApp”,
    “os”:“Windows10”,
    “timestamp”:“1620135027864”,
    “timezone”:{
      “bias”:−330.0,
      “dst”:“no”,
      “name”:“India Standard Time”
      }
    },
  “prod”:“XA.Receiver.Windows”,
  “prodVer”:“21.5.0.48”,
  “publicIPv4”:“49.206.14.162”,
  “publicIPv6”:“”,
  “splunk-sourcetype”:“XA.Receiver.Windows.Network.Info.Periodic”,
  “st”:“2021-05-04T13:30:27.000Z”,
    “tenant”:{
      “id”:“dtyz08c8bmj5”
  },
  “type”:“Network.Info.Periodic”,
  “user”:{
    “sAMAccountName”:“CITRITE\\vedavathih”
  },
    “ver”:“1”
}
```

In the example data packet provided above, the metrics may include data, analytics, and so forth relating to the network to which the endpoint 304 is connected (i.e., network name, network interface type, average upload and download speeds, maximum upload and download speeds, session identifier), data, analytics, and so forth related to the endpoint (i.e., computer manufacturer, computer name, hardware identifier, device identifier, etc.), and data related to the enterprise (i.e., a tenant identifier). As shown in FIG. 3, each of the workspace applications 306 (i.e., executing on the endpoints 304(1)-304(N) located across the geographic locations and connected to respective networks) may be configured to transmit metrics 308 to the server 302. The workspace applications 306 may be configured to generate data packets including the metrics at various intervals for sending to the server 302.

The system 300 is shown to include probe services 320. The probe services 320 may be or include any software, script, application, or executable code which is deployed for a network and configured to collect metrics relating to the network. The probe services 320 may be deployed at one or more of the geographic locations shown in FIG. 3. For example, while shown as deployed at the N-th geographic location and N-th network, various instances of the probe services 320 may be deployed at each (or a subset) of the geographic locations/networks shown in FIG. 3. The probe services 320 may be designed or implemented to collect metrics 308 similar to those described above. In some embodiments, the probe services 320 may be configured to probe a network in which the probe services 320 is deployed to collect metrics 308. In some embodiments, the probe services 320 may be deployed separate from the endpoints 304 (i.e., on a separate device or dedicated device). As such, the probe services 320 may generally not receive any inputs from users of an endpoint 304. Rather, the probe services 320 may be dedicated software or script which is configured to collect network metrics. The probe services 320 may be configured to transmit, send, or otherwise provide the metrics to the server(s) 302. The probe services 320 may be configured to provide the metrics to the server(s) 302 at various intervals (such as the same or similar intervals in which the workspace applications 306 transmit metrics to the server(s) 302 described above).

The system 300 is shown to include one or more servers 302. The server(s) 302 may be or include any device, component, computer, processor, or hardware deployed or otherwise implemented in a computing environment and configured to receive the metrics 308 from the workspace applications 308. In some embodiments, the server(s) 302 may be similar to the computers 100 and/or clients 165 described above with reference to FIG. 1A-FIG. 1C. In some embodiments, the server(s) 302 may be a component or device implemented in the computing environment 214 described above with reference to FIG. 2A-FIG. 2C. The server(s) 302 may include one or more services. The services may be or include any software, script, or machine-readable instructions executable by the server(s) 302 to perform various steps or functions. In some embodiments, the services may include a metrics analyzer 314 and an alert generator 316. Each of these services are described in greater detail below.

The server(s) 302 is shown to include a metrics analyzer 314. The metrics analyzer 314 may be any device, component, software, script, instructions, or other combination of hardware and/or software designed or implemented to parse, inspect, or otherwise analyze metrics 308 for the networks located at the various geographic locations. The metrics analyzer 314 may be configured to analyze the metrics 308 received from the workspace application(s) 306 and/or probe services 320 to identify potential network outages or degradations in network performance. As described in greater detail below, the metrics analyzer 314 may be configured to compare the metrics 308 (or one or more scores computed using the metrics 308) to a threshold. The metrics analyzer 314 may be configured to identify potential network outages or degradations in network performance based on the comparison.

The network analyzer 314 may be configured to receive or otherwise maintain location data relating to each of the geographic locations and/or networks of the geographic locations. For example, the network analyzer 314 may be configured to maintain location data relating to a network bandwidth for each of the networks, a location of each of the networks, internet service provider (ISP) details (i.e., ISP name, ISP identifier, etc.) for each of the networks, and user/endpoint details (usernames user identifiers of users which are authorized to access the network at a particular geographic location, device or endpoint identifiers of devices/endpoints 304 which are authorized to access the network at a particular geographic location, internet protocol (IP) address for the endpoints 304 authorized to access the network, etc.). In some embodiments, the network analyzer 314 may be configured to store the location data locally at the server(s) 302, such as in one or more data structures, databases, etc.

The network analyzer 314 may be configured to receive the metrics 308 from the workspace applications 306 and/or the probe services 320. In some embodiments, the network analyzer 314 may be configured to group each of the metrics 308 according to the corresponding network. The network analyzer 314 may be configured to parse the metrics 308 to identify a network name received in each of the metrics 308. The network analyzer 314 may be configured to group the metrics 308 using the network name (i.e., such that metrics 308 which are in a group have a shared or common network name).

The network analyzer 314 may be configured to determine an ISP for each of the networks based on IP addresses for the endpoints 304 obtained from the workspace applications 306. In some embodiments, the network analyzer 314 may be configured to access an IP-to-ISP application or resource which determines, detects, identifies, or otherwise derives ISP and/or location details from a public IP address. The network analyzer 314 may be configured to provide the IP address received from a workspace application 306 to the IP-to-ISP application or resource to determine the ISP and/or location of the endpoint 304.

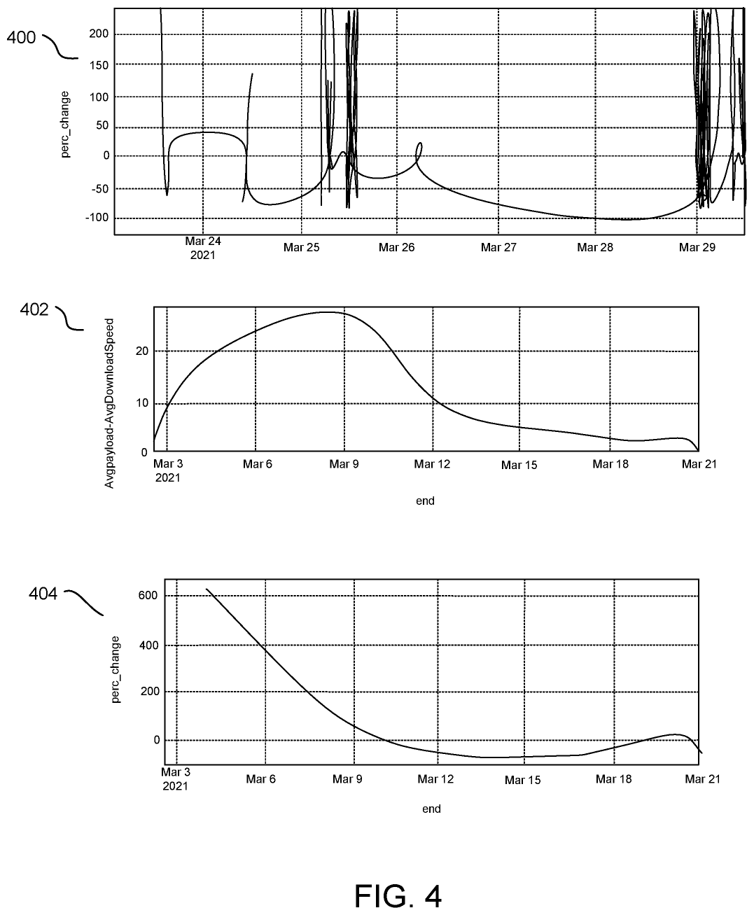

Referring now to FIG. 4, depicted are a series of charts 400, 402, 404 showing network performance of one or more networks over time. Specifically, chart 400 shows the percentage change in network performance for a particular internet service provider of a network over time, chart 402 shows an average download speed per payload for a particular internet service provider of a network over time, and chart 404 shows a percentage change in the average download speed for the internet service provider shown in chart 402. The network analyzer 314 may be configured to analyze the performance of the networks overtime to detect, predict, estimate, or otherwise determine potential or existing degradation in network performance. For example, and as described in greater detail below, the network analyzer 314 may be configured to compare the percentage changes in network performance, average download speed per payload, and/or percentage change in average download speed (generally referred to herein as metrics) to average or historical metrics for the internet service provider. The network analyzer 314 may be configured to detect, predict, or otherwise identify potential or existing degradation in network performance/outages based on the comparison. By proactively predicting degradation in network performances based on real-time metrics, the systems and methods described herein eliminate or decrease the likelihood of disruptions to an endpoint or network at a location by generating alerts which facilitate more rapid triage/mitigation of network performance issues. Such implementations may also decrease overall downtime. Additionally, by rapidly mitigating network performance issues, user experience may be improved by providing less latency and more rapid log-on and session network traffic.

Referring to FIG. 3 and FIG. 4, in some embodiments, the network analyzer 314 may be configured to compute a score based on the metrics 308. The score may be indicative of a performance of the network corresponding to the metrics 308. In some embodiments, the network analyzer 314 may be configured to compute or determine an average of the respective metrics 308 which are grouped together. For example, where the network analyzer 314 receives metrics 308 from a plurality of workspace applications 306 executing on endpoints 304 communicably coupled to the same network, the network analyzer 314 may be configured to compute an average of respective metrics 308 (i.e., an average download speed across the endpoints 304, an average upload speed across the endpoints 304, and so forth). The network analyzer 314 may be configured to compute the score for a network based on the average metrics 308 received from endpoints 304 communicably coupled to the network.

In some embodiments, the network analyzer 314 may be configured to compute the score based on a current (i.e., current average) network download speed in comparison to a daily average network download speed. For example, the network analyzer 314 may be configured to maintain or store (i.e., on the server 302 or in a different data structure) average metrics 308 for each of the networks of the system 300. The network analyzer 314 may be configured to compute the average metrics 308 on a rolling basis (i.e., each day, weekly, monthly, etc.). The network analyzer 314 may be configured to compare the current network download speed for a network (i.e., network download speed received in the metrics 308 from the workspace applications 306 of the network) to the daily average network download speed (i.e., stored or maintained by the network analyzer 314. In some embodiments, the network analyzer 314 may be configured to compute a performance score for the current network download speed. The network analyzer 314 may be configured to compute the performance score according to:

$${P}_{value} = ( \frac{{N}_{daily ( 2 )}}{{N}_{daily ( 1 )}} - 1 ) \times 100$$

where Pᵥₐₗᵤₑ is the performance score, N_{daily(2)} is the current average download speed (i.e., for the previous 15 minutes, for example) received in the metrics 308 from the workspace application 306 executing on the endpoints 304 communicably coupled to the network and N_{daily(1)} is the daily average download speed maintained by the network analyzer 314. The network analyzer 314 may be configured to compare the performance score to a threshold. In some embodiments, the threshold may be a predetermined threshold (i.e., set by the administrator). The threshold may be a percentage drop in the performance score (i.e., 10%, 15%, 20%, 25%, etc.).

The manager service 312 is shown to include an alert generator 316. The alert generator 316 may be any device, component, software, script, instructions, or other combination of hardware and/or software designed or implemented to generate alerts for rendering at one or more devices. The alert generator 316 may be configured to generate the alert(s) based on the comparison of the performance score to the threshold. In some embodiments, the alert generator 316 may be configured to generate the alert(s) responsive to the performance score not satisfying the threshold. For example, the alert generator 316 may be configured to generate the alert(s) responsive to the performance score being less than 20% (or another threshold). The alert generator 316 may be configured to transmit, send, or otherwise provide the alert to a device to indicate the drop in the performance score (i.e., indicating a degradation in network performance or a possible network outage). In some embodiments, the alert generator 316 may be configured to generate the alert for a device associated with the network having a performance score which does not satisfy the threshold. In some embodiments, the alert generator 316 may be configured to generate the alert for a computing device 310 for an administrator of the network. The alert generator 316 may be configured to determine which computing device 310 is associated with (i.e., is used by an administrator which services) the network. In some embodiments, the alert generator 316 may be configured to store or otherwise maintain data (i.e., in a data structure at the server 302 or at another device) which links particular networks with corresponding computing devices 310. The alert generator 316 may be configured to identify the device 310 by performing a look-up function in the data structure using the network name or other identifier of the network. The alert generator 316 may be configured to identify the device 310 to which to transmit the alert.

The alert generator 316 may be configured to transmit, send, or otherwise provide the alert to the device 310. The alert may be or include a notification or prompt which indicates a degradation in network performance of the network. In some embodiments, the notification or prompt may indicate or otherwise identify a current or potential network outage. The alert generator 316 may be configured to provide the alert to the device 310 to prompt a user of the device 310 to service the network, switch the geographic location from a primary network or internet service provider to a secondary network or internet service provider, and so forth.

In some embodiments, the alert generator 316 may be configured to generate alerts or notifications for the endpoints 304 communicably coupled to the network having a degradation in network performance. For example, the alert generator 316 may be configured to access the data structure which stores data on IP addresses of endpoints 304 communicably coupled to a particular network or located at a corresponding location. The alert generator 316 may be configured to generate an alert for each of the endpoints 304 having in IP address which is stored in the data structure in association with the network experiencing the degradation in network performance. The alert may indicate a degradation in network performance, and prompt users of the endpoints 304 to switch to a different network, to use resources which consume less bandwidth or do not require internet connectivity, etc.

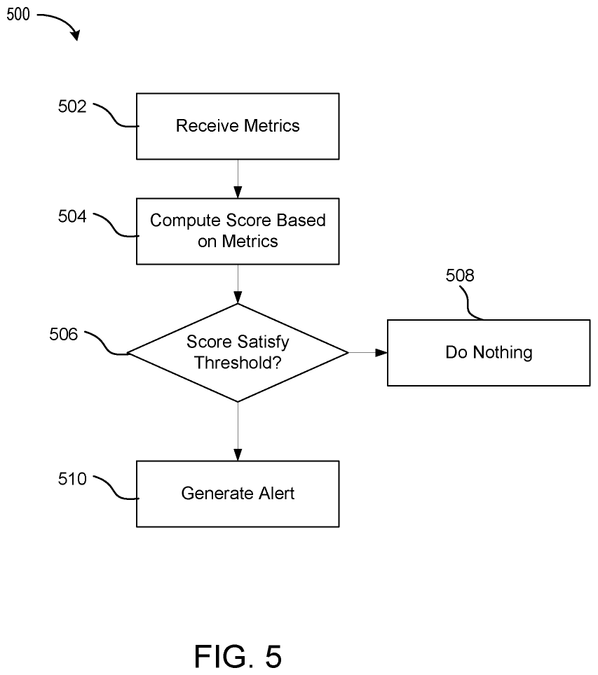

Referring now to FIG. 5, depicted is a flowchart showing an example method 500 for proactively alerting administrators of upcoming or possible network outages in a specific location, according to an illustrative embodiment. The steps of the method 500 shown in FIG. 5 may be performed by one or more of the devices or components described above with reference to FIG. 1A-FIG. 3. As a brief overview, at step 502, a server receives metrics. At step 504, the server computes a score based on the metrics. At step 506, the server determines whether the score satisfies a threshold. Where the score satisfies the threshold, the server may do nothing (i.e., may remain idle, may not take any action, etc.). On the other hand, where the score does not satisfy the threshold, the server may generate an alert.

At step 502, a server receives metrics. In some embodiments, the server may receive metrics from a plurality of workspace applications of a plurality of endpoints across a plurality of different locations of an enterprise. The metrics may be for usage of one or more networks for each workspace application. In some embodiments, the server may receive the metrics at various intervals. For example, the server may receive the metrics every five minutes, every ten minutes, every 15 minutes, every 30 minutes, every hour, etc. The server may receive the metrics responsive to the workspace applications generating a data packet or string which includes the metrics. In some embodiments, the server may receive metrics from the workspace applications and from probe services. The probe services may execute at the network locations and automatically generate, identify, determine, or otherwise acquire metrics relating to the network. The probe services may be dedicated services executing at the network locations and acquiring/sending metrics to the server.

The endpoints may be located across various geographic locations and communicably coupled to various networks at a respective geographic location. For example, a geographic location (such as a building, an office space, etc.) may include various endpoints. The geographic location may also include one or more networks which are used by the endpoints located at the geographic location. In some instances, a geographic location may include a plurality of networks (i.e., a primary and fallback network, for instance). Each endpoint may be communicably coupled to a respective network at a respective geographic location. Additionally, each endpoint may execute (or may be configured to execute) a workspace application. The workspace application may be software or a software suite, an application, etc. which executes on an endpoint to provide a user of the endpoint access to a plurality of local or remote resources. Each endpoint may execute a workspace application to provide a user of the endpoint access to the resources. The workspace applications may execute responsive to a user launching the workspace application, responsive to a user requesting access to a resource via the workspace application, etc. The workspace application may gather, acquire, compile, or otherwise receive metrics relating to the network responsive to executing on the endpoint. The workspace application may receive metrics relating to the network to which the endpoint is communicably coupled.

In some embodiments, the metrics may include, for example, a network download speed. The network download speed may be or include an average network download speed (i.e., as measured by a workspace application over a time duration). The network download speed may be a maximum download speed. In some embodiments, the metrics may also include an upload speed, a latency, a packet loss, or other metrics which are indicative of a strength of a network connection. In some embodiments, the metrics may include network download speed and network name, an address, network interface type and/or an internet service provider. Such embodiments may provide information on analytics for a network as well as identifying information for the network. The network interface type may include at least one of an Ethernet network interface, a Wi-Fi network interface, a token-ring network interface, a fiber distributed data interface (FDDI) network interface, a point-to-point (PPP) network interface, a loopback network interface, or a serial line internet protocol (SLIP) network interface.

At step 504, the server computes a score based on the metrics. In some embodiments, the server may compute a score based on a determined network download speed. For instance, the server may determine a network download speed for each location of the plurality of different locations according to the metrics for each workspace application. In some embodiments, the server may determine the network download speed for each location by computing an average of the network download speed received in metrics for each location. For example, the server may receive metrics from a plurality of endpoints for a common geographic location and network. The server may identify a network download speed in the metrics from each of the plurality of endpoints. The server may compute an average of the identified network download speed from the metrics.

In some embodiments, the server may compute a performance score based on the metrics including the network download speed. For example, the server may compute a performance score based on the network download speed and a previous network download speed. The server may compute the performance score based on a comparison of the network download speed for a current time interval (i.e., using the metrics received at step 502) to a network download speed for a previous time interval (i.e., using a value stored by the server in memory, in a data structure, or other database in association with a network identifier).

At step 506, the server determines whether the score satisfies a threshold. In some embodiments, the server may compare the score (i.e., the network download speed or a value computed, derived, or otherwise determined based on the network download speed) to a threshold. The threshold may be or include a percentage drop from a previous network download speed. For example, the threshold may be a 20% drop in average network download speed for a current time interval from a previous time interval. If the score satisfies the threshold (i.e., the current average network download speed is within 20% of the previous average network download speed or greater), the method may proceed to step 508. On the other hand, if the score does not satisfy the threshold (i.e., the current average network download speed has dropped by 20% or more from a previous average network download speed), the method may proceed to step 510.

Where the score satisfies the threshold, at step 508, the server may do nothing. For example, where the score satisfies the threshold, the server may remain idle, not take any actions, not take any alerts, etc. In some embodiments, where the score satisfies the threshold, the server may maintain a state of the network (i.e., to indicate that there is no degradation in network performance). In some embodiments, the server may remain idle until receiving metrics at a subsequent iteration (i.e., at the next interval in which the workspace applications on the endpoints send metrics to the server). For instance, the server may wait for a predetermined duration (i.e., a duration between the workspace applications sending metrics) and proceed back to step 502 following the predetermined duration.

Where the score does not satisfy the threshold, at step 510, the server may generate an alert. In some embodiments, the server may generate an alert to be provided to a device of a user associated with a first location of the plurality of different locations. The server may generate the alert responsive to the network download speed for a network of the one or more networks falling below the threshold. The server may transmit, send, or otherwise provide the alert to the device for rendering at the device. In some embodiments, the device may be used by or correspond to an administrator for the enterprise. The administrator may service the network which is experiencing a degradation in network performance. The administrator may service multiple networks including the network. The alert may indicate at least one of an existing network interruption or a potential network interruption. The server may maintain a list or ledger of devices for administrators in association with corresponding networks. The server may identify the device to which to transmit the alert using a network identifier for the network, using a network name for the network, etc. The server may transmit, send, or otherwise provide the alert to the device identified in the list or ledger as being associated with the network experiencing the degradation in network performance.

In some embodiments, the server may cause an endpoint connected to the network to render a notification indicating a degradation in network connectivity. For example, the server may maintain or otherwise access a database or data structure including identifiers for devices/endpoints which are communicably coupled to each network (or located at each geographic location). The server may identify which endpoints are communicably coupled to the network by using the network name or network identifier to extract or otherwise identify endpoints which are communicably coupled to the network from the database or data structure. The server may transmit the notification to each of the identified endpoints. The notification may indicate the degradation in network connectivity. In some embodiments, the notification may include instructions to instruct a user of the endpoint to switch to a different network, to access local resources, to use resources which do not consume as much bandwidth or do not require internet connectivity, etc.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method, comprising:
receiving, by one or more servers from a plurality of workspace applications of a plurality of endpoints across a plurality of different locations of an enterprise, metrics for usage of one or more networks for each workspace application at a respective location of the plurality of different locations;
determining, by the one or more servers, a network download speed for a first location of the plurality of different locations, using the metrics for two or more workspace applications at the first location; and
generating, by the one or more servers, an alert to be provided to a device of a user associated with the first location of the plurality of different locations responsive to the network download speed for a network of the one or more networks falling below a threshold.

2. The method of claim 1, wherein the workspace applications execute on endpoints to provide a user of the endpoint access to a plurality of local or remote resources.

3. The method of claim 1, wherein the metrics comprise an average network download speed for a current time interval, and wherein the threshold comprises a percentage drop of the average network download speed for the current time interval from an average network download speed for a previous time interval.

4. The method of claim 1, wherein the metrics comprise network download speed and at least one of a network name, an address, a network interface type, or an internet service provider for the respective networks.

5. The method of claim 4, further comprising computing, by the one or more servers, a performance score based on the metrics including the network download speed, wherein the alert is generated responsive to the performance score falling below the threshold.

6. The method of claim 4, wherein the network interface type comprises at least one of an Ethernet network interface, a Wi-Fi network interface, a token-ring network interface, a fiber distributed data interface (FDDI) network interface, a point-to-point (PPP) network interface, a loopback network interface, or a serial line internet protocol (SLIP) network interface.

7. The method of claim 1, wherein the alert indicates at least one of an existing network interruption or a potential network interruption.

8. The method of claim 1, wherein at least some of the metrics are received from a plurality of probe services executing at the respective network locations.

9. The method of claim 1, wherein at least some of the plurality of networks including the network are located at a common geographic location, and wherein the alert indicates that the first network located at the common geographic location is experiencing an degradation in network connectivity.

10. The method of claim 1, further comprising causing, by the one or more servers, an endpoint connected to the network to render a notification indicating a degradation in network connectivity.

11. A system, comprising:
one or more processors configured to:
receive, from a plurality of workspace applications of a plurality of endpoints across a plurality of different locations of an enterprise, metrics for usage of one or more networks for each workspace application at a respective location of the plurality of different locations;
determine a network download speed for a first location of the plurality of different locations, using the metrics for two or more workspace applications at the first location; and
generate an alert to be provided to a device of a user associated with the first location of the plurality of different locations responsive to the network download speed for a network of the one or more networks falling below a threshold.

12. The system of claim 11, wherein the workspace applications execute on endpoints to provide a user of the endpoint access to a plurality of local or remote resources.

13. The system of claim 11, wherein the metrics comprise an average network download speed for a current time interval, and wherein the threshold comprises a percentage drop of the average network download speed for the current time interval from an average network download speed for a previous time interval.

14. The system of claim 11, wherein the metrics comprise network download speed and at least one of a network name, an address, a network interface type, or an internet service provider for the respective networks.

15. The system of claim 14, wherein the one or more processors are further configured to compute a performance score based on the metrics including the network download speed, wherein the alert is generated responsive to the performance score falling below the threshold.

16. The system of claim 14, wherein the network interface type comprises at least one of an Ethernet network interface, a Wi-Fi network interface, a token-ring network interface, a fiber distributed data interface (FDDI) network interface, a point-to-point (PPP) network interface, a loopback network interface, or a serial line internet protocol (SLIP) network interface.

17. The system of claim 11, wherein the alert indicates at least one of an existing network interruption or a potential network interruption.

18. The system of claim 11, wherein at least some of the metrics are received from a plurality of probe services executing at the respective network locations.

19. The system of claim 11, wherein at least some of the plurality of networks including the network are located at a common geographic location, and wherein the alert indicates that the first network located at the common geographic location is experiencing an degradation in network connectivity.

20. A non-transitory computer-readable medium storing instructions that, when executed by one or more processors, cause the one or more processors to:
receive, from a plurality of workspace applications of a plurality of endpoints across a plurality of different locations of an enterprise, metrics for usage of one or more networks for each workspace application at a respective location of the plurality of different locations;
determine a network download speed for a first location of the plurality of different locations, using the metrics for two or more workspace applications at the first location; and
generate an alert to be provided to a device of a user associated with the first location of the plurality of different locations responsive to the network download speed for a network of the one or more networks falling below a threshold.
